(19) United States
(12) Patent Application Publication
(10) Pub. No.: US 2009/0073950 A1
(43) Pub. Date: Mar. 19, 2009

(54) Wireless Audio Gateway Headset

(75) Inventors: Darren S. Guccione, Wheaton, IL (US); Craig B. Lurey, El Dorado Hills, CA (US)

Correspondence Address: Levenfeld Pearlstein, LLC;Intellectual Property Department, 2 North LaSalle, Suite 1300, Chicago, IL, 60602, US

(73) Assignee: CALLPOD INC., Chicago, IL (US)

(21) Appl. No.: 11/857,521

(22) Filed: Sep. 19, 2007

(51) Int. Cl. H04Q 7/20; H04B 15/00; H04R 25/00; H04L 12/28

(52) U.S. Cl. 370/341; 370/254; 381/375; 381/94.2

(57) ABSTRACT

A wireless, multi-function audio gateway device provides communication between the headset and at least one audio gateway. The headset includes a housing having at least one multifunction button, and a first and a second microphone. The first microphone is located closer to a user's mouth than the second microphone. The headset also includes a flexible ear bud, a speaker, a volume control button, a rechargeable battery, a USB port, a detachable ear wrap, and a programmable baseband IC. The programmable baseband IC is configured for wireless communications to allow interfacing between the at least one audio gateway and the wireless headset. Methods for improved noise suppression, pairing and communicating with multiple audio gateways simultaneously, and allowing headset-to-headset communications between two wireless, multiple audio gateway headsets are also disclosed.

### BACKGROUND OF THE INVENTION

The present invention is directed to a wireless headset. More particularly, the present invention pertains to a wireless headset compatible with multiple wireless communications-enabled devices.

With the advent of wireless communications technology, headsets, particularly wireless headsets, are gaining in popularity. However, by the nature of the physical location of a typical wireless headset on a person's ear, the headset is always susceptible to background noise. It is well known by the layman that the closer a microphone is to a user's mouth, the clearer the speech will be heard on the other end. As the distance between the mouth and the headset grows, the effects of background noise become more and more apparent, and can even overtake the magnitude of the sound waves coming from the speaker's mouth.

Most headsets are designed with boom microphones that physically sit in front of the user's mouth, or directional plastics that protrude toward the person's mouth in an attempt to pick up the user's speech and compensate for the background noise interference. In the latter case, there has been some success, albeit limited, in creating a headset which is able to pick up the speaker's voice while having a physical protrusion toward the mouth. However, the problem still exists where a user's voice is muffled by background interference.

In addition, headsets are normally fashioned for pairing with only one wireless communications-enabled audio-gateway. However, a growing number of headset users have multiple audio gateway devices. For example, users have several audio gateways including mobile phones, landlines, personal digital assistants, VoIP and wireless communications-enabled music players. To date, there is no easy, efficient way of connecting all these devices with one headset at once and switching between the devices as necessary.

Accordingly, there is a need for an enhanced wireless headset. Desirably, such a headset can create an environment in which the sound coming from the speaker's voice is optimized while sound coming from any other location is suppressed without muffling effects or distortion of the speaker's voice.

In addition, it is also desirable to keep its computational complexity to a minimum so that it is most conducive for subsequent hardware implementation, and for extending the battery life of the headset. Lastly, it is desirable to keep the overall time delay of the audio processing pipeline to a minimum and greatly enhance the speech quality even in the presence of multiple, very strong background interferences without having detrimental effects on the speaker.

### BRIEF SUMMARY OF THE INVENTION

A wireless, multi-function audio gateway device, such as a headset for providing communication between the headset and at least one audio gateway is disclosed. The headset comprising a housing having at least one multifunction button, a first and a second microphone. The first microphone is located closer to a user's mouth than the second microphone. The headset includes a flexible ear bud, a speaker, a volume control button, a rechargeable battery, a USB port, a detachable ear wrap, and a programmable baseband IC. The programmable baseband IC is configured for wireless communications to allow interfacing between the up to at least seven audio gateways and the wireless headset.

In addition, the headset is designed for enhanced noise suppression, pairing with multiple audio gateways simultaneously, and for allowing headset-to-headset communications between two wireless, multiple audio gateway headsets.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is an isometric view of a present embodiment of the wireless audio gateway;

FIG. 2 is an isometric view of the wireless audio gateway, showing the ear bud and ear wrap of the present embodiment;

FIG. 3 is an isometric view showing a plug in a port of an embodiment of the wireless audio gateway;

FIG. 4 is an isometric view of the ear wrap of the wireless audio gateway;

FIG. 5A-5D are isometric views of the wireless audio gateway illustrating the changing of the ear wrap;

FIG. 6 is a block diagram of the electrical and software components of the wireless audio gateway;

FIG. 7 is an electrical schematic illustrating a portion of FIG. 6;

FIG. 8 is an electrical schematic illustrating a portion of FIG. 6.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

The wireless audio gateway headset 10 is a Bluetooth® compatible, Class-1 headset that allows a user to make and receive calls from a Bluetooth®-enabled phone or computer. Referring now to the figures, the outer hardware of the headset 10 is composed of a power/volume control button 16, red and blue LED lights 18, 19 respectively, a multifunction button 20, dual microphones an anterior microphone 22 and a posterior microphone 237 a speaker 24, a charging port/USB port 26, an ear bud 287 and a detachable ear wrap 30.

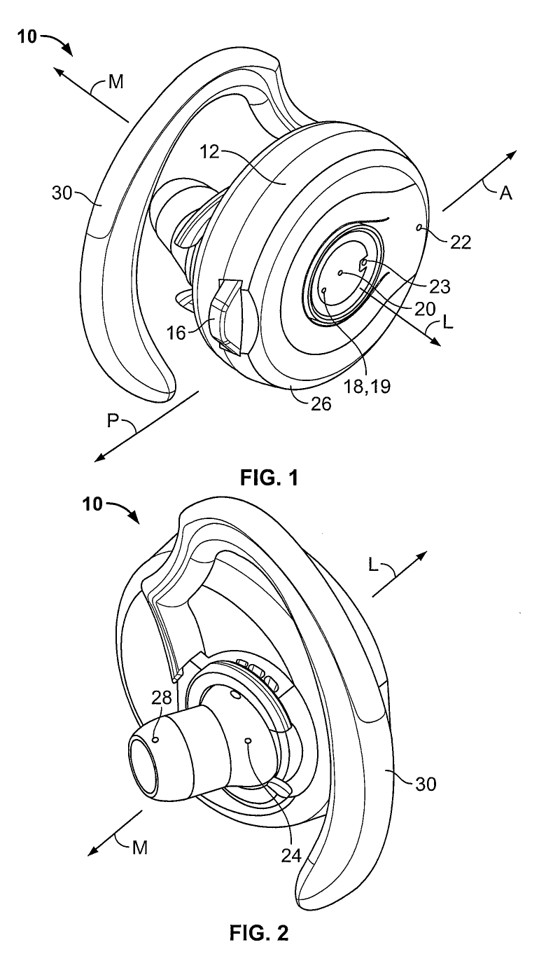

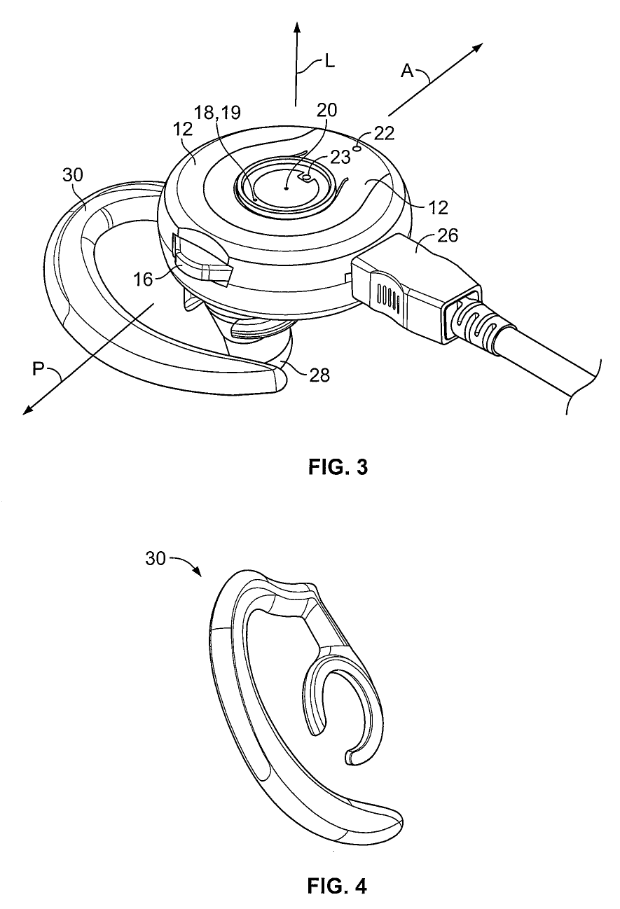

Turning in particular to FIGS. 1-3, FIG. 1 shows the headset 10 configured for placement on the right ear. The power/volume control button 16 serves both a power function and volume control function. The button 16 in the present embodiment is located on the posterior P aspect of the housing 12. Pushing the power button 16 “in” powers the headset 10 up, while toggling the power button 16 operates the volume control.

Red/blue LEDs 18, 19 are located on the lateral L aspect of the headset 10 housing 12, posterior to the anterior and posterior microphones 22, 23. The LEDs 18, 19 in the present embodiment flash red and blue during power cycling and pairing; however, different colors and configurations are contemplated.

A multifunction button 20 is located in the center, lateral aspect of the housing 12. The multifunction button 20 opens and closes an audio channel, mutes an audio channel, and switches between two active audio channels. Other functions may also be controlled by the multifunction button 20.

The dual microphones, anterior microphone 22 and posterior microphone 23, are positioned within the housing 12 such that when a user wears the headset, the anterior microphone 22, configured for the human voice, is located anterior to the posterior microphone 23, relative to the human body. The posterior microphone 93 is positioned posterior to the anterior microphone 22 and is configured for background sounds. The anterior A and posterior P directions are illustrated in FIGS. 1-3 using directional arrows. Small openings in the housing 12 allow sound to pass through the housing 12 into the microphones 22, 23. The dual microphones 22, 23 are preferably positioned such that the anterior microphone 22 is closer to the user's mouth than the posterior microphone 23.

The headset 10 is powered by an internal battery, such as a lithium-ion rechargeable battery. In a present configuration, the red indicator light or red LED 18 will illuminate during charging. When charging is complete, the red LED 18 will turn off. The full performance of a new battery is achieved only after two or three complete charge and discharge cycles.

If the battery becomes low on power while the headset is in use, a short beep will be heard approximately every 20 seconds. Charging components are available to allow charging via a USB port on a computer, AC/DC wall adapter or car charger.

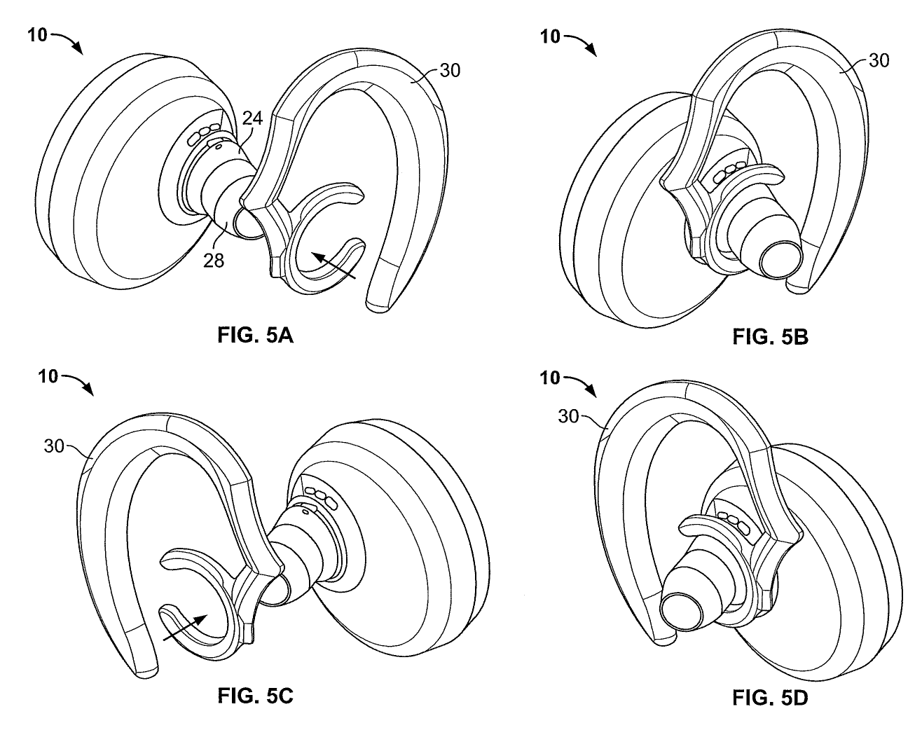

The soft, flexible ear bud 28 and the detachable, adjustable ear wrap 30 allow for comfortable placement of the headset 10 in either the right or the left ear. The ear bud 28 nests in the user's ear snugly. The ear wrap 30 is detachable and can be converted to be used for either ear, as shown in FIGS. 4 and 5a-d.

The headset 10 allows the user to talk on the phone or over a computer (audio gateway) wirelessly, with minimal background interference. In addition, the headset 10 allows for one headset 10 to be connected to up to seven (7) different wireless communications-enabled audio gateways, including another headset 10, wherein all connections have enhanced audio and noise suppression.

While the headset 10 is configured for use with Bluetooth® communications protocol, it is contemplated that the headset 10 can and will be configured for use with other wireless communications protocols, including, but not limited to WiFi, Zigbee, Wibree or other future protocols that support audio communications.

Features of the headset 10 include noise mitigation, multiple audio gateway handling, and headset-to-headset communications.

The headset 10 utilizes a noise mitigation procedure, which shall herein be referred to as Dual-Microphone Noise Suppression. Dual-Microphone Noise Suppression automatically turns on during a call and significantly reduces background noise to optimize and enhance the sound quality of the conversation. The microphone configuration and software implementation create an environment in which the sound coming from the speaker's voice is optimized while sound coming from any other location is suppressed. This is carried out without muffling effects or distortion of the speaker's voice. In a present headset 10, this is accomplished using an 11 mm separation between microphones, allowing hardware to be of a small form factor.

The headset 10 also has multiple audio gateway handling capability. The headset 10 can pair with up to at least seven (7) wireless communications-enabled devices at once, two (2) of which can be active simultaneously. The linked devices, both active and inactive connections, are not aware of each other and do not interfere with each other's links. Multiple audio gateway ability allows for a seamless transition between devices with minimal time lag between switching.

The headset 10 includes headset-to-headset communication capability. Two headsets 10 are used. A first headset 10 can be converted to an audio gateway during its power up phase. A second headset 10 can then establish a link with the first headset 10 that has been converted to an audio gateway (“converted headset”). Both the headset and the converted headset have the ability to end the link, mute the link, and transition between calls when paired with other wireless communications enabled devices.

Typical wireless communications enabled devices transmit up to 30 feet. However, because the headset 10 is a Class-1 wireless communications enabled device, the headset has an operating range of up to three hundred twenty-eight (328) feet when connected to another Class-1 device, which makes it ideal for small office, field and home environments.

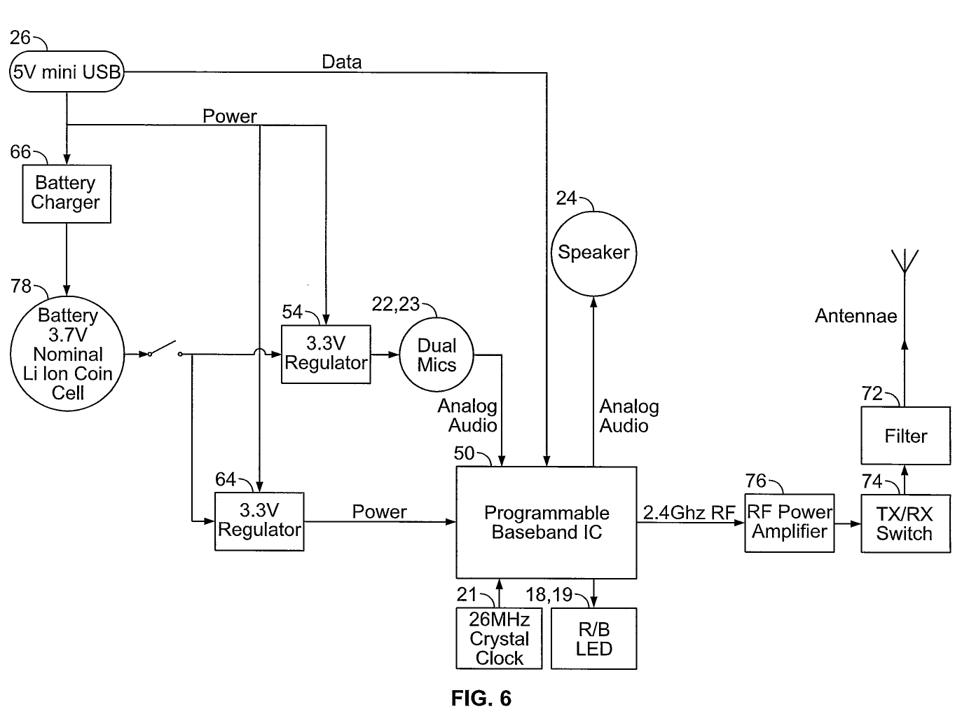

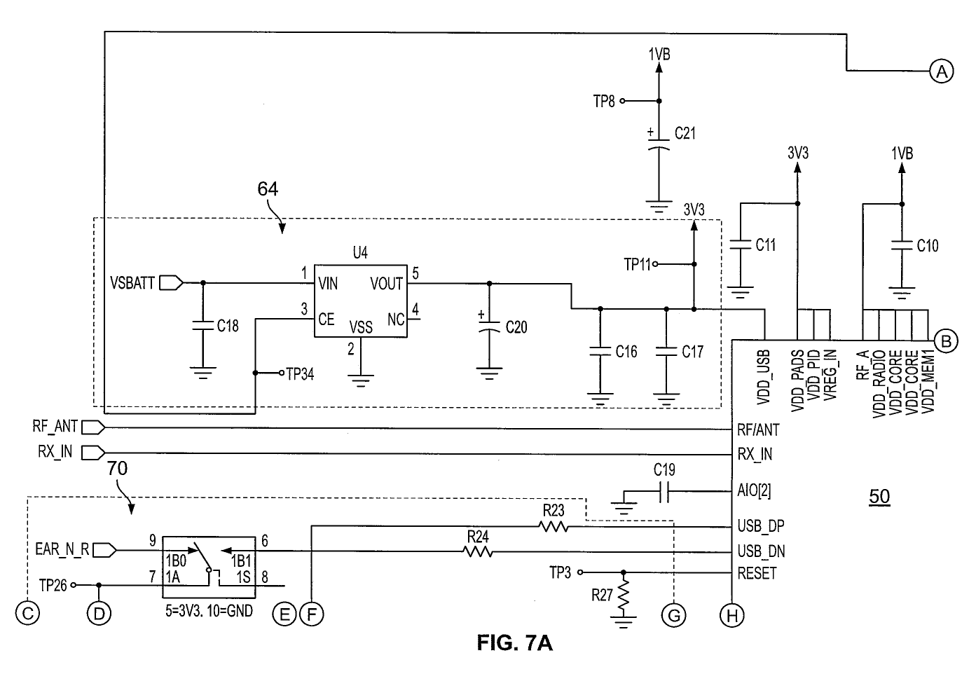

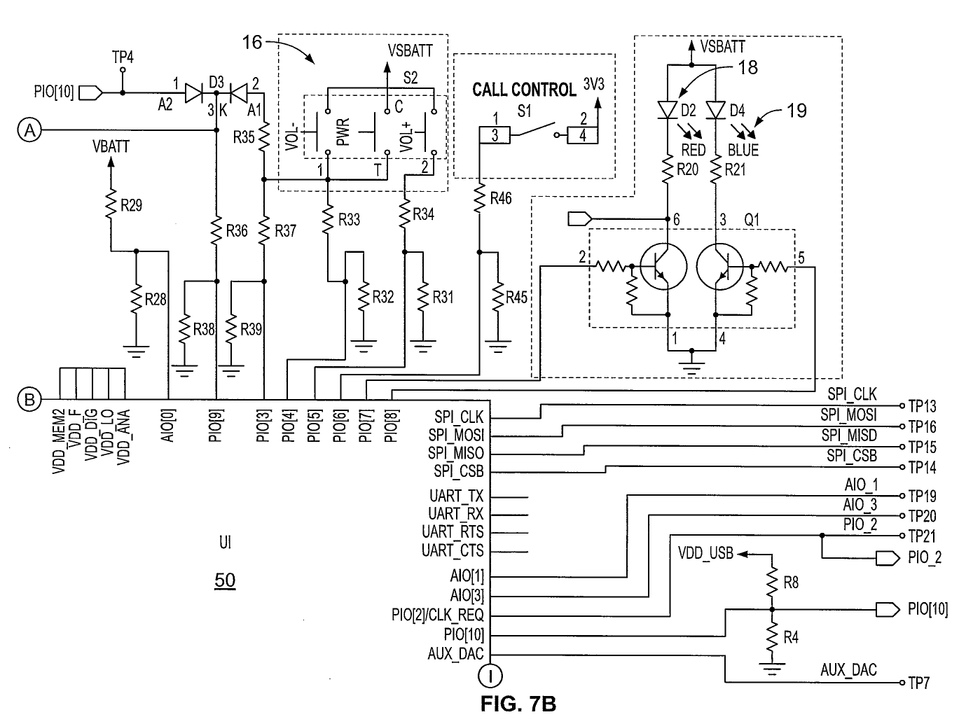

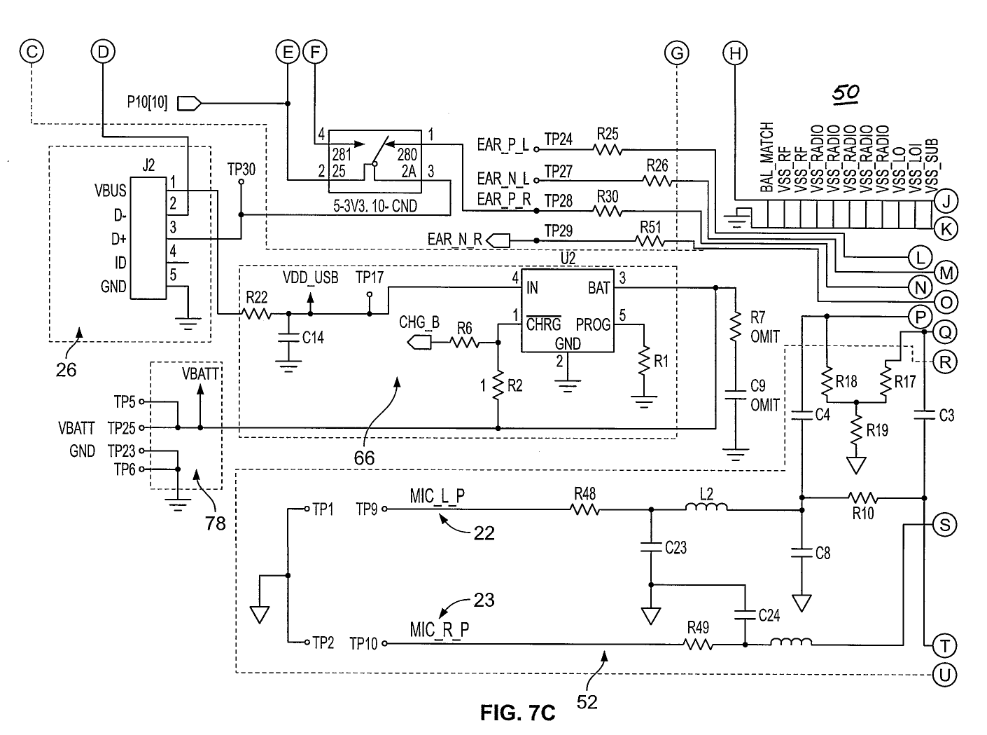

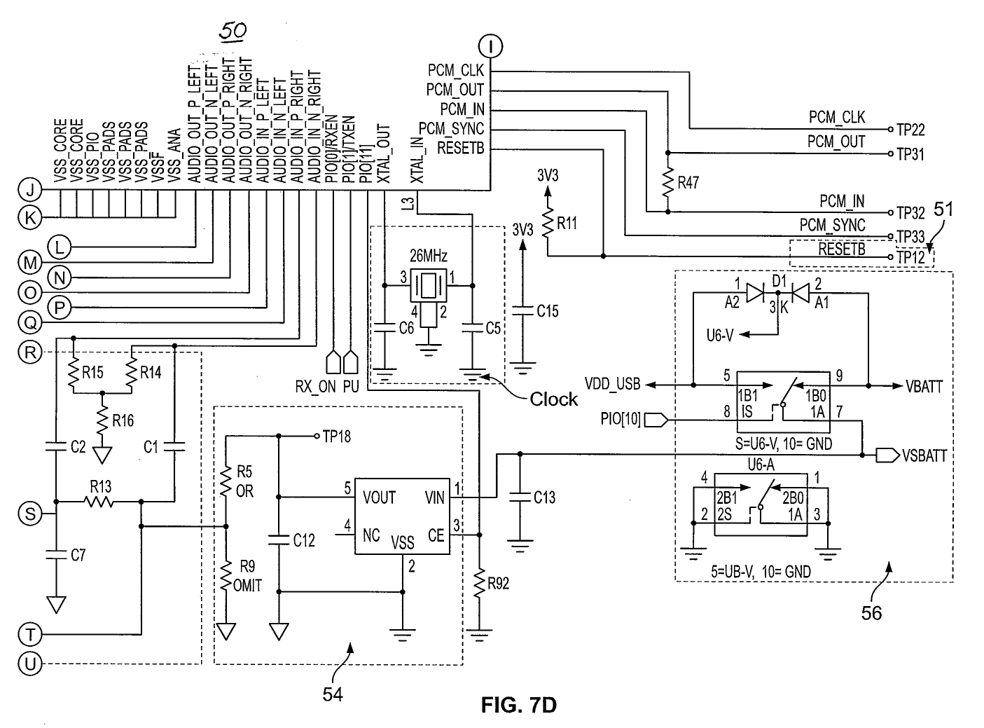

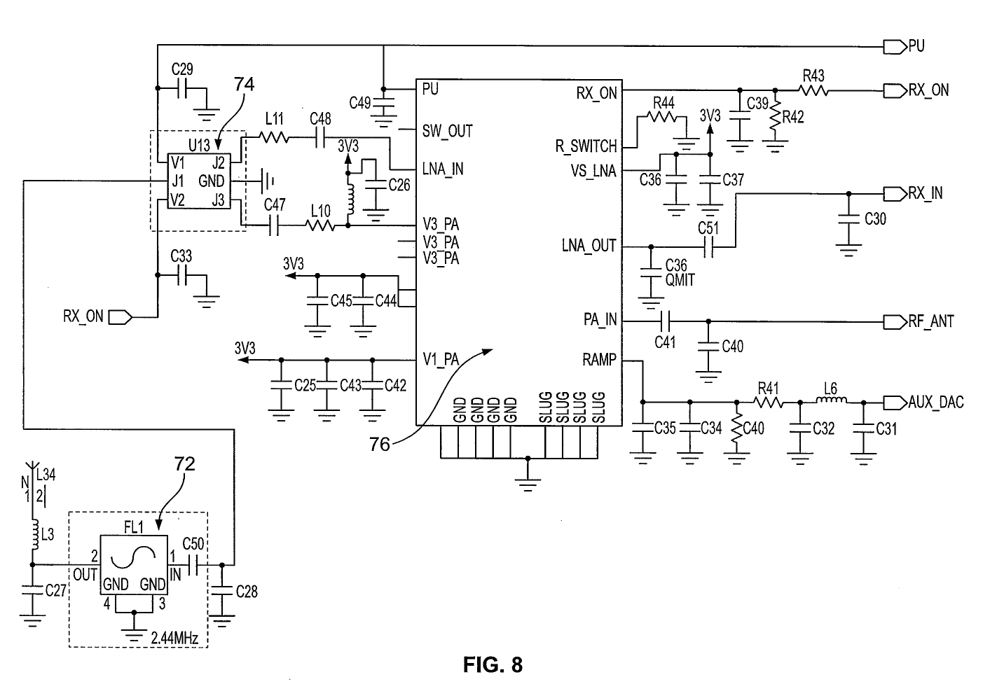

The block diagram of FIG. 6 and the electrical circuitry of FIGS. 7-8 illustrate how the headset 10 works. The present embodiment has two sources of power: an internal, rechargeable lithium-ion battery supply 72 and an external supply via a 5V mini USB port 26. A battery charger circuit 66 for the internal battery 78 is also shown.

The analog circuitry for the anterior and posterior microphones 22, 23 is separated from the digital circuitry. As is known in the art, good design practice includes separating digital and analog circuits, as the analog signals may infect the digital signals. Thus, two voltage regulators, analog voltage regulator 54 and digital voltage regulator 64 are used to regulate the voltage to approximately 3.3V each. Analog voltage regulator 54 is used to regulate power for the analog inputs from the dual microphones 22, 23 and the digital voltage regulator 64 is used to control voltage for the digital components of the circuit. No matter the battery level, there is a constant voltage on the power lines and the microphones 22, 23.

Dual microphone noise suppression is a speech pre-conditioning section aimed at suppressing all frequencies that are not of the immediate speaker. In other words, dual microphone noise suppression removes all background noises, including other people's voices or audio, if the voice or audio is not that of the headset 10 user. By the nature of the physical location of a headset on a person's ear, the headset is always susceptible to background noise. Noise suppression is accomplished by using band pass filters, followed by alignment of the inputs, and noise cancellation. In other words, an audio delay algorithm is used that can exploit the time difference between the audio signals from the two microphones 22, 23 and an adaptive noise cancellation algorithm can constructively combine audio signals from the two microphones 22, 23 while suppressing interfering background noise.

As can be seen in FIG. 6 part A and FIG. 7, the schematic of part A, the analog signals from the dual microphones 22, 23, each pass through external band-pass filters 52. The band-pass filters 52 remove non-speech audio. For examples let X1 and X2 represent the buffer of audio samples coming from the anterior 22 and posterior 23 microphones, respectively. Each buffer is run through a real-time band-pass filter 52 to remove frequencies below and above the voice channel.

This is input into the programmable baseband IC 50. Within the IC 50 there is an analog to digital conversion of the audio signal. The DSP work (Digital Signal Processing) is done using the digital audio. The actual audio used is PCM, Pulse Code Modulated, a standard method of digitally encoding audio.

During the alignment phase, based on the separation of microphones 22, 23 on the headset and the sample rate of the incoming digital audio data, the audio samples coming into each microphone 22, 23 can be time-aligned. There is an 11 mm distance between the microphones 22, 23; thus, sound from the anterior microphone 22 can be differentiated from and enhanced compared to background noise received by posterior microphone 23.

X1 and X2 represent the buffer of audio samples coming from the anterior and posterior microphones 22, 23, respectively. Samples are shifted into these buffers at a sample rate, typically 8 ksamples/sec.

Let W represent a buffer of filter coefficients of length L. As each sample is shifted into the buffers X1 and X2, the X1 buffer is multiplied and accumulated (MAC) against the buffer of filter coefficients W, stored as value r1. Based on the separation between the microphones, a sample delay is chosen to align the two input buffers from X2, in which a value r2 is chosen at each sample period. r1 and r2 represent the aligned samples at each sample period. By aligning the samples in such a manner, the next processing block (beamformer) is able to eliminate unwanted background noise.

In the “beamformer” phase, differentiation and enhancement occurs based in part on the separation of the anterior and posterior microphones 22, 23. The posterior microphone 23 is place further away from the user's voice than the anterior microphone 22. Because the speed of sound in the air is a known factor, if anterior microphone 22 is placed closer to a user's mouth, the sound from the user's voice will be received by the anterior microphone 22 first before being received by the posterior microphone 23. In the same manner, background noise from behind and the side of the user should be received by the posterior microphone 23 first, then the anterior microphone 22.

The IC 50 is designed/programmed for a desired voice/audio frequency spectrum and the time lapse between sounds, such that unwanted frequencies (outside of voice frequencies) coming from the posterior microphone 23 and/or the anterior microphone 22 can be isolated and eliminated. Analog and digital band pass filters are used—a filter programmed in software and encoded within IC 50, and also hardwired, analog band-pass filters for each microphone 22, 23, as illustrated in FIG. 7 at 52. Unwanted frequencies are subtracted from the audio stream and canceled, forming a “beam” of enhanced audio.

During the beamformer phase, r1 and r2 represent the aligned audio sample buffers of the anterior and posterior microphones 22, 23, respectively, and W1 and W2 represent two buffers of filter coefficients of length N. As newly aligned samples are shifted into r1 and r2, the buffers are multiplied and accumulated (MAC) against W1 and W2, respectively. The result of this filter operation produces 2 samples, y1 and y2. y1 and y2 are added together to create the final output sample Y. Y is clipped to prevent overflow. W1 and W2 are adaptive filter coefficients. After each sample Y is generated, W1 and W2 buffers are updated based on the previous state of the input buffers.

The audio is digitally processed, for a Class 2 power rating, a range of approximately 30 feet. With an external RF power amplifier 76, the RF can be modulated and the power rating can be increased such that the headset 10 becomes a Class 1 power rated device, having a range of approximately 300 feet.

Particular attention should be paid to the low algorithmic complexity and low time delay. Audio DSP occurs in approximately 2 ms. A crystal oscillator, or Clock 21, provides the clock for the circuit, in the present embodiment operating at 6 mHz.

Powering the headset 10 occurs by the power from the 5V USB 26 or the power from the battery 78. When the 5V USB 26 is connected to a computer, 5V is present from the computer to power the headset 10 circuit; thus, the battery 78 is not needed. The entire circuit is provided with power from the external 5V USB 26 supply rather than the internal battery 78. When the external 5V supply is not present, the circuit relies on the battery 78. In this manner the battery 78 can be charged without draining.

FIG. 8 shows a schematic of part B of FIG. 6, the antenna, a band pass filter 72, a switch 74 for transmission and receiving, and an amplifier 76 to amplify the signal sent to the audio gateway.

From the preceding, it will be appreciated that multiple audio gateways can be established. The headset 10 can be paired simultaneously with up to at least seven (7) Bluetooth® or wireless communications-enabled devices at once, with at least two wireless communications-enabled devices having active channels.

The headset 10 can store pairing information with at least seven devices without having to re-pair. At least two of those devices may be active simultaneously to the headset 10. For instance, a user can connect to a cell phone and to a computer for accepting Skype® calls.

The multiple audio gateways are established by the headset 10 establishing one hands free service on one channel. A first audio gateway pairs with the headset 10 on a first channel and a first hands free connection is established. Thereafter, the headset 10 unregisters the service on the first channel and registers a second service on a second channel so that a second audio gateway can establish a hands free connection. In this manner, at least 7 audio gateways may be paired with the headset 10.

When one of the paired audio gateways (AG) requests an audio link, the headset 10 can respond and immediately turn on/open/activate the paired channel without delay by pressing the multi-function button 20. Two of the seven paired audio gateways may be connected with the headset 10 simultaneously and a user can bounce between the two active gateways seamlessly. Neither audio gateways have knowledge of the other.

When connected to two devices, the headset 10 is able to control call handling through the multifunction button 20. For example, if the headset 10 is connected to a call on a cell phone and a call comes in from a Skype® account the call can be answered by pressing the multifunction button 20. After the Skype® call has ended, the headset 10 will automatically return to the mobile phone call.

Headset-to-headset communications allows two people to communicate in full duplex over 250,000 sq. ft. using the multi-function button 20 on the headset 10. To do so, two headsets 10 are used. One headset (headset B) is reversed to act as an AG while the other headset (headset A) remains in normal mode. Headset A is in a discoverable state and headset B is powered off. Headset B is then powered back on while holding the multifunction button 20. After a few moments, headset B will seek out headset A and automatically establish the connection.

When the two headsets A, B are connected, either pasty can speak in fail duplex at the same time with no voice cancellation. The audio channel is opened and closed/activated and inactivated by pressing the multifunction button 20 once; the multifunction button 20 need not be held down. Using the multifunction button 20 to open and close the audio channel between the headsets A, B significantly increases talk time versus having the audio channel open continuously. Either user can open, close or mute the channel.

Headset B, which has itself been converted to an audio gateway, can still connect to another audio gateway. When in a headset-to-headset mode, the headset 10, which has been converted to AG mode, can still function as a standard wireless communications-enabled headset. Therefore, a user can be speaking headset-to-headset, using the converted headset B, press the multifunction button 20, then be talking through a cell phone. The converted headset may be used as an AG on one active channel and as a normal-mode headset 10 on another active channel and switch back and forth between the two active channels.

When powered off and on, the converted headset B goes back into “normal mode” which is the same as when converted to an AG except that the headset-to-headset functionality is disabled.

To turn the headset 109 in normal mode, on, the power/volume control button 16 is pressed until the red LED 18 illuminated the headset 10 will play an ascending tone and the LED will flash red and blue indicating that it is ready to pair. To turn the headset 10 off, press and hold the power/volume control button 16 until the red LED 18 turns off. The headset 10 will play a descending tone and then shut off.

In order to pair the headset 10 with an AG, the headset is powered on and will first attempt to reconnect to the last phone used (if any). If the phone is out of range or not available, the headset 10 will automatically enter a discoverable state. A period of time is available to pair the headset 10 with a cell phone or PC before it enters a low power sleep mode. If the device is not paired within the allotted time, in the present embodiment, 60 seconds, a user may push the power/volume control button 16 and the headset 10 will enter discoverable mode for another 60 seconds.

To search for available headset 10 form a phone or computer the appropriate option is selected from the AG and a pass code is entered when prompted. If necessary, the phone or computer is instructed to complete the connection with the headset 10. Pairing the headset 10 with a particular phone and/or computer need be done only once; afterwards, the headset 10 is selected from a menu when it is to be used.

If the user is currently connected to a phone, in order to pair another device, the headset 10 needs to be in discoverable mode. The power/volume control button 16 is pressed once to enable this feature. The blue and red LEDs 18, 19 will flash and the user may now begin pairing the headset 10 to a second device.

The headset 10 will automatically switch between two connected devices based on which device has requested an active audio channel.

To disconnect a headset 10 from a current AG device, the headset 10 is either powered off or the pairing memory is cleared. To turn off the headset 10, the power/volume control button 16 is pressed and held, until the red LED 18 turns off. To clear the pairing memory of the headset 10, the multifunction button 20 is pressed and held until the LED lights blue 19 and red 18 at the same time. The headset 10 will then enter a discoverable state.

When powered on, the headset 10 will automatically reconnect to the last connected phone. If the headset 10 is on, but not connected to any devices, pressing the multifunction button 20 will establish a connection to the last connected phone.

Once the headset 10 is connected to a phone, the phone may be dialed as usual. The headset 10 will automatically turn on when the call is placed. If supported by, the phone, the headset 10 may also engage the voice-dialing feature of the cell phone.

When the headset 10 rings, an incoming call can be accepted by pressing the multifunction button 20. If a call is already present, the first call will be placed on hold. The multifunction button 20 can be pressed to switch between calls, or the multifunction button can be pressed and held to join the calls in a conference.

While on a single call, the call can be muted and unmuted by pressing the multifunction button 20. While on a single call, press and hold the multifunction button to end the call.

To increase or decrease the speaker volume, the power/volume control button 16 is toggled up or down. Note that the volume control directions are opposite when the headset 10 is in the left ear than when in the right ear. FIGS. 5A-D illustrate changing the ear wrap 30 to accommodate right and left ear users. The opening of the ear wrap 30 slides over the ear bud 28 and clips into channels located on the ear bud 28.

In an alternate embodiment, a switch 70 is available which can switch back and forth with the 5V USB 26 and the analog audio to provide surround sound for the user. There exist two pins on the 5V USB 26 bus for data transfer; when plugged the headset 10 is linked to a computer via the 5V USB port 26, 5V obtained from the computer switches the switch 70 and the line is configured for data transfer, enabling the passing of data to the headset 10 from the computer to the IC 50. The user can “talk” to the IC 50 using the 5V USB 26 interface for upgrades or other information passing. As soon as the 5V USB 26 connection is removed, the 5V disappears because it was being provided by the computer. When the 5V disappears, the switch 70 switches such that an analog audio-out for a second speaker is made available, enabling the user to have sound in stereo if desired.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A wireless, multiple audio gateway headset for providing communication between the headset and at least one audio gateway, the headset comprising:
a housing, the housing having at least one multifunction button, a first and a second microphone, wherein the first microphone is located closer to a user's mouth than the second microphone, a flexible ear bud, a speaker, a volume control button, a rechargeable battery, and a USB port;
a detachable ear wrap; and
a programmable baseband IC, wherein the programmable baseband IC is configured for wireless communications for interfacing between the at least one audio gateway and the wireless headset, and wherein an audio sample is processed in approximately 2 milliseconds.

2. The wireless, multiple audio gateway headset for providing communication between the headset and at least one audio gateway of claim 1, wherein the headset has a range of 300 feet.

3. The wireless, multiple audio gateway headset for providing communication between the headset and at least one audio gateway of claim 1, wherein the headset answers, mutes, and terminates transmissions.

4. The wireless, multiple audio gateway headset for providing communication between the headset and at least one audio gateway of claim 1, wherein the first and the second microphones are approximately 11 mm apart.

5. The wireless, multiple audio gateway headset for providing communication between the headset and at least one audio gateway of claim 1, wherein the first microphone is located closer to an audio source than the second microphone.

6. The wireless, multiple audio gateway headset for providing communication between the headset and at least one audio gateway of claim 1, wherein the headset includes dual microphone noise suppression.

7. A method for suppressing background noise for a wireless, multiple audio gateway device, the method comprising the steps of:
collecting first analog audio signals from a first microphone;
collecting second analog audio signals from a second microphone;
filtering the first analog audio signals from the first microphone through a first bandpass filter to remove non-speech audio;
filtering the second analog audio signals from the second microphone through a second bandpass filter to remove non-speech audio;
converting the first and second analog audio signals to first and second digital signals;
aligning the first and second digital signals;
exploiting the time difference between the digital audio signals from the first microphone and the digital audio signals from the second microphone to remove background noise and undesired speakers;
eliminating an undesired frequency spectrum; and
adding the first and the second digital signals to create a final enhanced output.

8. The method for suppressing background noise for a wireless, multiple audio gateway device of claim 7, the method further comprising the step of passing the digital signals through a bandpass filter.

9. The method for suppressing background noise for a wireless, multiple audio gateway device of claim 7, wherein the first and the second microphones are separated by approximately 11 millimeters.

10. The method for suppressing background noise for a wireless, multiple audio gateway device of claim 7, wherein the first microphone is closer to an audio source than the second microphone.

11. A method for communicating with multiple audio gateways simultaneously for a wireless, multiple audio gateway device, the method comprising the steps of:
registering a first hands free service on a first channel on the device;
pairing a first audio gateway with the device on the first channel;
unregistering the first service on the first channel;
registering a second service on a second channel;
pairing a second audio gateway with the device on the second channel; and
activating the first channel; and
activating the second channel.

12. The method for communicating with multiple audio gateways simultaneously for a wireless, multiple audio gateway device of claim 11, further comprising the step of controlling a call with a multifunction button located on the device.

13. The method for communicating with multiple audio gateways simultaneously for a wireless, multiple audio gateway device of claim 11, wherein the device is paired with a plurality of audio gateways forming a plurality of audio gateway connections.

14. The method for communicating with multiple audio gateways simultaneously for a wireless, multiple audio gateway device of claim 11, wherein the device is paired with up to at least seven (7) audio gateways forming the up to at least seven (7) audio gateway connections.

15. The method for communicating with multiple audio gateways simultaneously for a wireless, multiple audio gateway device of claim 13, wherein at least two of the paired audio gateways connections are active and wherein a user switches between the at least two active audio gateways.

16. The method for communicating with multiple audio gateways simultaneously for a wireless, multiple audio gateway device of claim 15, wherein a user transfers between the at least two active audio gateways without inactivating one of the at least two gateways.

17. The method for communicating with multiple audio gateways simultaneously for a wireless, multiple audio gateway device of claim 16 wherein the device automatically returns to a first active audio gateway connection when a second active audio gateway connection becomes inactive.

18. The method for communicating with multiple audio gateways simultaneously for a wireless, multiple audio gateway device of claim 11, wherein the device operates in a range over 300 feet.

19. The method for communicating with multiple audio gateways simultaneously for a wireless, multiple audio gateway device of claim 15 wherein neither a first active audio gateway connection nor a second active audio gateway connection is aware of the other.

20. The method for communicating with multiple audio gateways simultaneously for a wireless, multiple audio gateway device of claim 15 wherein the paired audio gateway connections cause no interference with each other.

21. A method for allowing headset-to-headset communications between two wireless, multiple audio gateway devices, the method comprising:
converting a first device to an audio gateway;
having a second device in a normal mode;
placing the second device in a discoverable state;
establishing a connection between the first device and the second device by having the second device seek out the first device.

22. The method for allowing headset-to-headset communications between two wireless, multiple audio gateway devices of claim 21, wherein the headset-to-headset communication is in full-duplex.

23. The method for allowing headset-to-headset communications between two wireless, multiple audio gateway devices of claim 21, wherein the device in headset-to-headset communication mode has a range of at least 250,000 square feet.

24. The method for allowing headset-to-headset communications between two wireless, multiple audio gateway devices of claim 21 wherein the device which is in the discoverable mode retains the normal mode ability.

25. The method for allowing headset-to-headset communications between two wireless, multiple audio gateway devices of claim 21, wherein the one or both of the first device and the second device control the connection.
